(19) United States
(12) Patent Application Publication
(10) Pub. No.: US 2013/0135528 A1
(43) Pub. Date: May 30, 2013

(54) Broadcasting Receiver and Television Set

(71) Applicant: Alexandru NICU, Singapore (SG)

(72) Inventor: Alexandru NICU, Singapore (SG)

(73) Assignee: Funai Electric Co., Ltd., Daito-shi (JP)

(21) Appl. No.: 13/306,373

(22) Filed: Nov. 29, 2011

(51) Int. Cl. H04N 5/455; H04N 3/27

(52) U.S. Cl. 348/552; 348/726; 348/554; 348/E05.113

(57) ABSTRACT

This broadcasting receiver includes a front-end having an RF receiver receiving a broadcast signal and a decoder separating the broadcast signal received by the RF receiver into a video signal and an audio signal and a back-end provided separately from the front-end, outputting the video signal and the audio signal input from the front-end through the decoder. The front-end can be connected to and disconnected from the back-end.

### BACKGROUND OF THE INVENTION

1. Field of the Invention

The present invention relates to a broadcasting receiver and a television set, and more particularly, it relates to a broadcasting receiver and a television set each including a front-end and a back-end.

2. Description of the Background Art

A broadcasting receiver or the like including a front-end and a back-end is known in general, as disclosed in Japanese Patent Laying-Open No. 2008-48201, for example.

The aforementioned Japanese Patent Laying-Open No. 2008-48201 discloses a digital broadcast receiver (television set) including a front-end receiving a broadcast signal and a back-end outputting a video signal and an audio signal on the basis of a TS (transport stream) signal demodulated in the front-end. In this digital broadcast receiver described in Japanese Patent Laying-Open No. 2008-48201, the front-end and the back-end are provided in different control circuit portions physically separated from each other. In this case, the control circuit portion constituting the back-end is fixed to a television set body whereas the control circuit portion constituting the front-end is formed to be capable of making both a connection to and a disconnection from the control circuit portion of the back-end through a USB cable.

In this digital broadcast receiver (television set), the front-end is provided with an encryption portion encrypting the TS signal before separation of the received broadcast signal into the video signal and the audio signal and decode of the same, and the back-end is provided with a decryption portion decrypting the encrypted TS signal. Thus, the TS signal before the separation and decode is transferred to the back-end through the USB cable in a state where the same is temporarily encrypted in the front-end, and thereafter is decrypted in the decryption portion of the back-end. Therefore, a decoder to separate the TS signal after the decryption into the video signal, the audio signal, etc. and decode the same is mounted on the control circuit portion of the back-end.

However, in the conventional broadcasting receiver (television set) disclosed in the aforementioned Japanese Patent Laying-Open No. 2008-48201, the decoder is mounted on the back-end fixed to the television set body, and hence it is disadvantageously difficult to replace the decoder with another decoder, perform upgrade to amend software driving the decoder serving as hardware, and the like.

Further, in the conventional broadcasting receiver (television set) disclosed in the aforementioned Japanese Patent Laying-Open No. 2008-48201, it is necessary to additionally provide the encryption portion and the decryption portion for the TS signal in the front-end and the back-end, respectively, in order to perform communication between the front-end and the back-end separated from each other. Thus, the control circuit portions constituting the front-end and the back-end in the broadcasting receiver are disadvantageously complicated.

### SUMMARY OF THE INVENTION

The present invention has been proposed in order to solve the aforementioned problems, and an object of the present invention is to provide a broadcasting receiver and a television set in which at least a decoder can be easily replaced and upgrade of at least the decoder can be easily performed while the structure of a front-end and a back-end can be inhibited from complication even when the front-end and the back-end capable of being physically separated from each other are employed.

A broadcasting receiver according to a first aspect of the present invention includes a front-end having an RF receiver receiving a broadcast signal and a decoder separating the broadcast signal received by the RF receiver into a video signal and an audio signal, and a back-end provided separately from the front-end, outputting the video signal and the audio signal input from the front-end through the decoder. The front-end can be connected to and disconnected from the back-end.

The “front-end” defined in the present invention denotes a component having a function of receiving a broadcast signal in the broadcasting receiver. Further, the “back-end” defined in the present invention denotes a component having a function of outputting the video signal and the audio signal included in the received broadcast signal.

As hereinabove described, the broadcasting receiver according to the first aspect of the present invention includes the front-end having the decoder separating the broadcast signal received by the RF receiver into the video signal and the audio signal and the back-end provided separately from the front-end, and the front-end can be connected to and disconnected from the back-end. Thus, only the existing front-end can be easily replaced with a new front-end mounted with another decoder without replacing the back-end, and the existing front-end can be easily amended by easily upgrading software driving the decoder serving as hardware. Therefore, at least the decoder can be easily replaced, and upgrade of at least the decoder can be easily performed.

In the broadcasting receiver according to the first aspect, if the front-end and the back-end are formed separately from each other, the front-end includes the decoder, and hence the video signal and the audio signal after decode by the decoder can be transferred from the front-end to the back-end. If the video signal and the audio signal after the decode by the decoder are transferred from the front-end to the separate back-end on the basis of the HDMI standard communication specification in which copyright is protected, for example, no arithmetic processing portion or the like for temporal encryption and decryption of the transferred video signal and audio signal may be additionally provided in the front-end and the back-end. Thus, the structure of the front-end and the back-end can be inhibited from complication even when the front-end and the back-end capable of being physically separated from each other are employed.

In the aforementioned broadcasting receiver according to the first aspect, the front-end is preferably formed detachably from a receiver body. According to this structure, the front-end can be easily detached from the receiver body to be replaced in response to a delivery format, for example, and hence broadcast signals delivered in various delivery formats can be received by the same broadcasting receiver. Further, the front-end includes the decoder, and hence the front-end mounted with a new version of the decoder corresponding to a delivery format can be easily connected to the existing receiver body including the back-end. Thus, the broadcasting receiver can be redesigned as a broadcasting receiver capable of receiving a desired broadcast signal by replacing only the front-end in the existing receiver body without renewal (replacement) of the whole broadcasting receiver by a user.

In the aforementioned broadcasting receiver according to the first aspect, the front-end and the back-end provided separately from each other are preferably connected with each other to be capable of performing communication based on an HDMI standard, and the video signal and the audio signal obtained by separation of the broadcast signal by the decoder of the front-end are preferably input from the front-end to the back-end in a signal format based on the HDMI standard. According to this structure, the communication based on the HDMI standard does not generate deterioration of data associated with compression and decompression, and the video signal and the audio signal can be transferred from the front-end to the back-end.

In this case, the front-end can preferably be controlled by a control signal transmitted from the back-end on the basis of the HDMI standard. According to this structure, the front-end including the RF receiver can be easily controlled from the receiver body including the back-end by effectively employing a communications protocol defined in the HDMI standard.

In the aforementioned broadcasting receiver according to the first aspect, the front-end preferably further includes a decryption processor cancelling copy protection included in the broadcast signal. According to this structure, the front-end including the decoder is provided with the decryption processor, and hence in the front-end, the decoder can reliably separate the broadcast signal in which the copy protection has been cancelled by the decryption processor into the video signal and the audio signal and decode the same.

In the aforementioned broadcasting receiver according to the first aspect, power for activating the front-end is preferably supplied from the back-end to the front-end in a state where the front-end and the back-end provided separately from each other are connected with each other. According to this structure, no power supply portion (power circuit portion) provided for driving the front-end may be provided in the front-end, and hence the structure of the front-end can be further inhibited from complication. Further, the receiver body can be formed such that a power supply portion for the back-end is also employed as a power supply portion for the front-end, and hence the structure of the broadcasting receiver can be simplified due to the shared power supply portion.

In the aforementioned broadcasting receiver according to the first aspect, the back-end is preferably provided with a transmitter receiving an operation signal for operating a receiver body, and the operation signal received by the transmitter of the back-end is preferably transmitted to the front-end so that the front-end operates on the basis of the operation signal. According to this structure, the front-end (RF receiver) can easily operate on the basis of the operation signal representing channel selection, for example, that the transmitter of the back-end receives even when the front-end and the back-end are formed separately from each other.

In the aforementioned broadcasting receiver according to the first aspect, the front-end preferably includes a first printed circuit board mounted with the decoder while the back-end preferably includes a second printed circuit board, and the first printed circuit board of the front-end is preferably detachably connected to the second printed circuit board of the back-end. According to this structure, the first printed circuit board and the second printed circuit board separated from each other can constitute the front-end and the back-end, respectively, and hence the front-end and the back-end can be easily formed separately from each other. Further, the first printed circuit board and the second printed circuit board are physically connected with each other, whereby the front-end and the back-end provided separately from each other can be easily connected with each other.

In the aforementioned structure in which the front-end includes the first printed circuit board and the back-end includes the second printed circuit board, the first printed circuit board and the second printed circuit board can preferably be connected with each other through connecting members capable of performing communication based on an HDMI standard. According to this structure, the first printed circuit board and the second printed circuit board can be reliably connected with each other through the connecting members. Further, the connecting members capable of performing the communication based on the HDMI standard are employed to connect the front-end and the back-end with each other, whereby communication between the front-end and the back-end having been connected with each other can be easily performed on the basis of the HDMI standard.

In this case, the connecting members preferably include a male header provided on the first printed circuit board and a female receptacle provided on the second printed circuit board, and the first printed circuit board can preferably be connected to the second printed circuit board by inserting the male header of the first printed circuit board into the female receptacle of the second printed circuit board. According to this structure, the male header is arranged on the first printed circuit board attached to the second printed circuit board while the female receptacle is arranged on the second printed circuit board attached with the first printed circuit board, and hence the front-end including the first printed circuit board can be easily connected to the back-end including the second printed circuit board by simply inserting the convex male header into the concave female receptacle.

In the aforementioned broadcasting receiver according to the first aspect, the RF receiver is preferably detachably mounted on the front-end. According to this structure, only the RF receiver serving a receiving function can be replaced while a body of the front-end remains in the broadcasting receiver, and hence the RF receiver can be easily replaced in response to a delivery format when broadcast signals are delivered in various delivery formats.

In the aforementioned structure in which the RF receiver is detachably mounted on the front-end, the front-end preferably further includes a third printed circuit board mounted with the RF receiver in addition to a first printed circuit board mounted with the decoder, and the third printed circuit board is preferably detachably connected to the first printed circuit board. According to this structure, the third printed circuit board can constitute the RF receiver while the first printed circuit board separated from the third printed circuit board can constitute the front-end including components other than the RF receiver, and hence in the front-end, the RF receiver and a portion other than the RF receiver can be easily formed separately from each other. Further, the first printed circuit board and the third printed circuit board are physically connected with each other, whereby the RF receiver can be easily connected to the front-end.

In this case, the third printed circuit board is preferably arranged to be superimposed on the first printed circuit board. According to this structure, the third printed circuit board is superimposed on the first printed circuit board, and hence the installation area of the third printed circuit board can be included in the installation area of the first printed circuit board. Thus, the installation area of the front-end can be inhibited from increase, dissimilarly to a case where the first printed circuit board and the third printed circuit board are arranged adjacent to each other in the same plane, for example.

In the aforementioned structure in which the RF receiver is detachably mounted on the front-end, the RF receiver can preferably receive a control signal transmitted from an external system in addition to the broadcast signal, and the front-end can preferably be controlled by the control signal transmitted from the external system that the RF receiver can receive. The external system denotes a management system provided in a place other than the broadcasting receivers in order for a facility to manage the broadcasting receivers in an integrated fashion when a plurality of the broadcasting receivers are set in a hotel, a leisure facility, a school, a hospital, or the like. According to this structure, the external system managing the plurality of broadcasting receivers together can be employed to control each of the broadcasting receivers properly.

The aforementioned broadcasting receiver according to the first aspect preferably further includes a rear cabinet covering the back-end and having a first opening while the front-end is formed detachably from a receiver body through the first opening of the rear cabinet. According to this structure, the front-end may not be detached in a state where the whole rear cabinet covering the back-end is detached from the receiver body when the front-end is detached from the receiver body. In other words, the front-end can be detached through the first opening without detaching the rear cabinet, and hence the front-end can be easily detached.

In the aforementioned structure further including the rear cabinet, the broadcasting receiver preferably further includes a first cover member covering the first opening of the rear cabinet and the front-end while the front-end can be detached from the receiver body through the first opening by detaching the first cover member from the first opening. According to this structure, the front-end can be easily detached by simply detaching the first cover member from the first opening of the rear cabinet and exposing the front-end from the first opening when the front-end is detached from the receiver body.

In this case, the RF receiver can preferably receive a control signal transmitted from an external system in addition to the broadcast signal and is detachably mounted on the front-end, the RF receiver corresponding to the receivable broadcast signal and control signal transmitted from the external system is preferably mounted on the front-end, and the first cover member preferably includes a second opening provided to correspond to a position where the RF receiver of the front-end is mounted, and the broadcasting receiver preferably further includes a second cover member mounted on the first cover member to cover the second opening of the first cover member while the RF receiver can be detached through the second opening by detaching the second cover member from the first cover member in a state where the first cover member covers the front-end. According to this structure, the RF receiver may not be detached in a state where the whole first cover member covering the front-end is detached from the rear cabinet so that the front-end is exposed from the first opening when the RF receiver in the front-end is detached. In other words, the RF receiver can be detached through the second opening by detaching only the second cover member without detaching the first cover member, and hence the RF receiver can be easily detached.

In the aforementioned broadcasting receiver according to the first aspect, the front-end can preferably be slid in substantially the same plane in which the back-end is arranged to be detached from the back-end of a receiver body. According to this structure, the front-end can be easily detached from the back-end of the receiver body.

A television set according to a second aspect of the present invention includes a front-end having an RF receiver receiving a television broadcast signal and a decoder separating the television broadcast signal received by the RF receiver into a video signal and an audio signal, a back-end provided separately from the front-end, outputting the video signal and the audio signal input from the front-end through the decoder, a display displaying the video signal output from the back-end, and sound speakers outputting the audio signal output from the back-end. The front-end can be connected to and disconnected from the back-end.

As hereinabove described, the television set according to the second aspect of the present invention includes the front-end having the decoder separating the television broadcast signal received by the RF receiver into the video signal and the audio signal and the back-end provided separately from the front-end, and the front-end can be connected to and disconnected from the back-end. Thus, only the existing front-end can be easily replaced with a new front-end mounted with another decoder without replacing the back-end, and the existing front-end can be easily amended by easily upgrading software driving the decoder (hardware). Therefore, at least the decoder can be easily replaced, and upgrade of at least the decoder can be easily performed.

In the television set according to the second aspect, if the front-end and the back-end are formed separately from each other, the front-end includes the decoder, and hence the video signal and the audio signal after decode by the decoder can be transferred from the front-end to the back-end. Thus, no arithmetic processing portion or the like for temporal encryption and decryption of the transferred video signal and audio signal may be additionally provided in the front-end and the back-end in order to perform communication between the front-end and the back-end separated from each other. Consequently, the structure of the front-end and the back-end can be inhibited from complication even when the front-end and the back-end capable of being physically separated from each other are employed.

In the aforementioned television set according to the second aspect, the front-end is preferably formed detachably from a television set body. According to this structure, the front-end can be easily detached from the television set body to be replaced in response to a delivery format, for example, and hence television broadcast signals delivered in various delivery formats can be received by the same television set. Thus, the television set can be redesigned as a television set capable of receiving a desired television broadcast signal by replacing only the front-end in the existing television set body including the back-end without renewal (replacement) of the whole television set by a user.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a television set according to an embodiment of the present invention, as viewed from a front side;

FIG. 2 is perspective view of the television set according to the embodiment of the present invention, as viewed from a rear side;

FIG. 3 is a block diagram of a control circuit portion constituting the television set according to the embodiment of the present invention;

FIG. 4 is a plan view showing the structure of a television set body of the television set according to the embodiment of the present invention in a state where a rear cabinet is detached, as viewed from the rear side;

FIG. 5 is a sectional view of the television set body taken along the line 500-500 in FIG. 4;

FIG. 6 is a diagram showing a state where a front-end is slid in a transverse direction to be mounted on the television set body of the television set according to the embodiment of the present invention;

FIG. 7 is a diagram showing a state where the television set body of the television set according to the embodiment of the present invention is mounted with the front-end and further mounted with a first cover member and a second cover member;

FIG. 8 is a diagram showing a state where the second cover member is detached from the front-end of the television set according to the embodiment of the present invention in order to replace an RF receiver; and

FIG. 9 is a diagram showing a state where a front-end is mounted on a television set body of a television set according to a modification of the present invention from a rear side toward a front side.

### DESCRIPTION OF THE PREFERRED EMBODIMENTS

An embodiment of the present invention is now described with reference to the drawings.

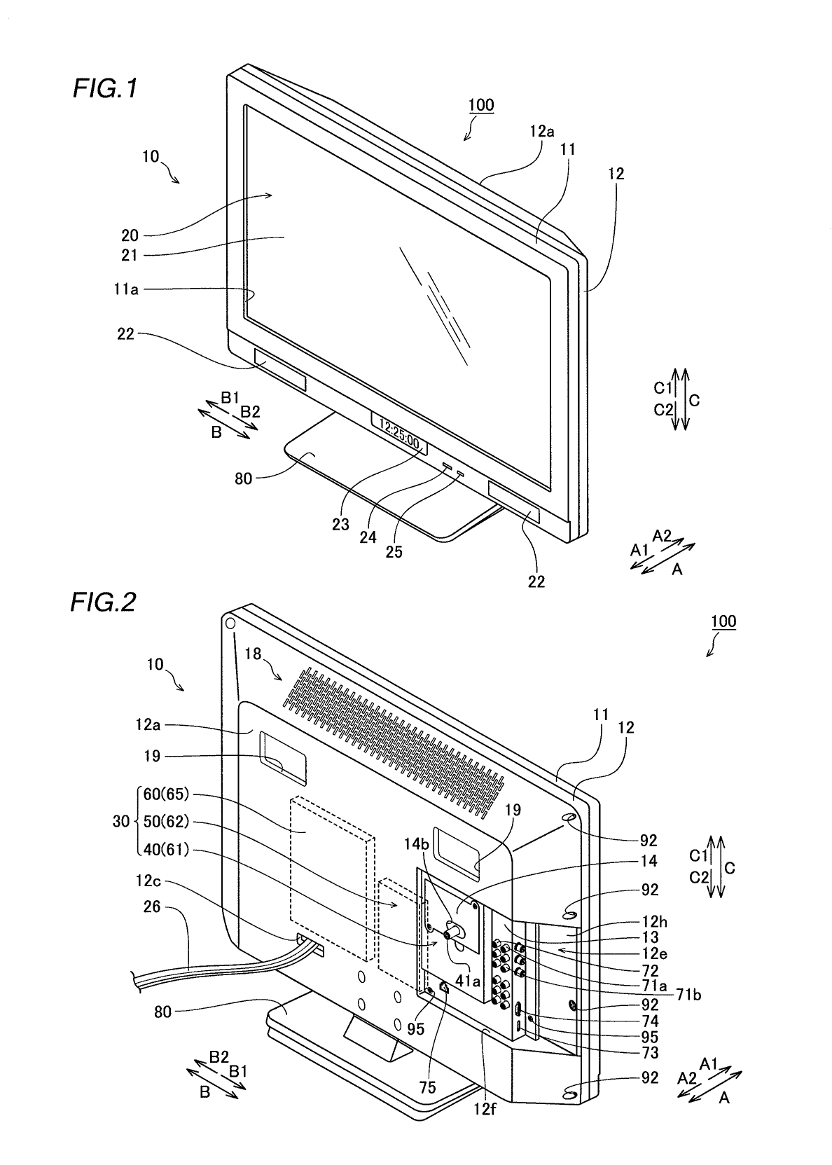

The structure of a liquid crystal television set 100 according to the embodiment of the present invention is described with reference to FIGS. 1 to 8. The liquid crystal television set 100 is an example of the “broadcasting receiver” and the “television set” in the present invention.

The liquid crystal television set 100 according to the embodiment of the present invention includes a television set body 10 and a stand portion 80 supporting the television set body 10 from below (C2 side), as shown in FIG. 1. The liquid crystal television set 100 includes the stand portion 80, and hence the television set body 10 can be placed on the upper surface of a table, a television rack, or the like, for example. The television set body 10 includes a front cabinet 11 of resin, a rear cabinet 12 of resin, and a display 20 arranged between the front cabinet 11 and the rear cabinet 12. The television set body 10 is an example of the “receiver body” in the present invention.

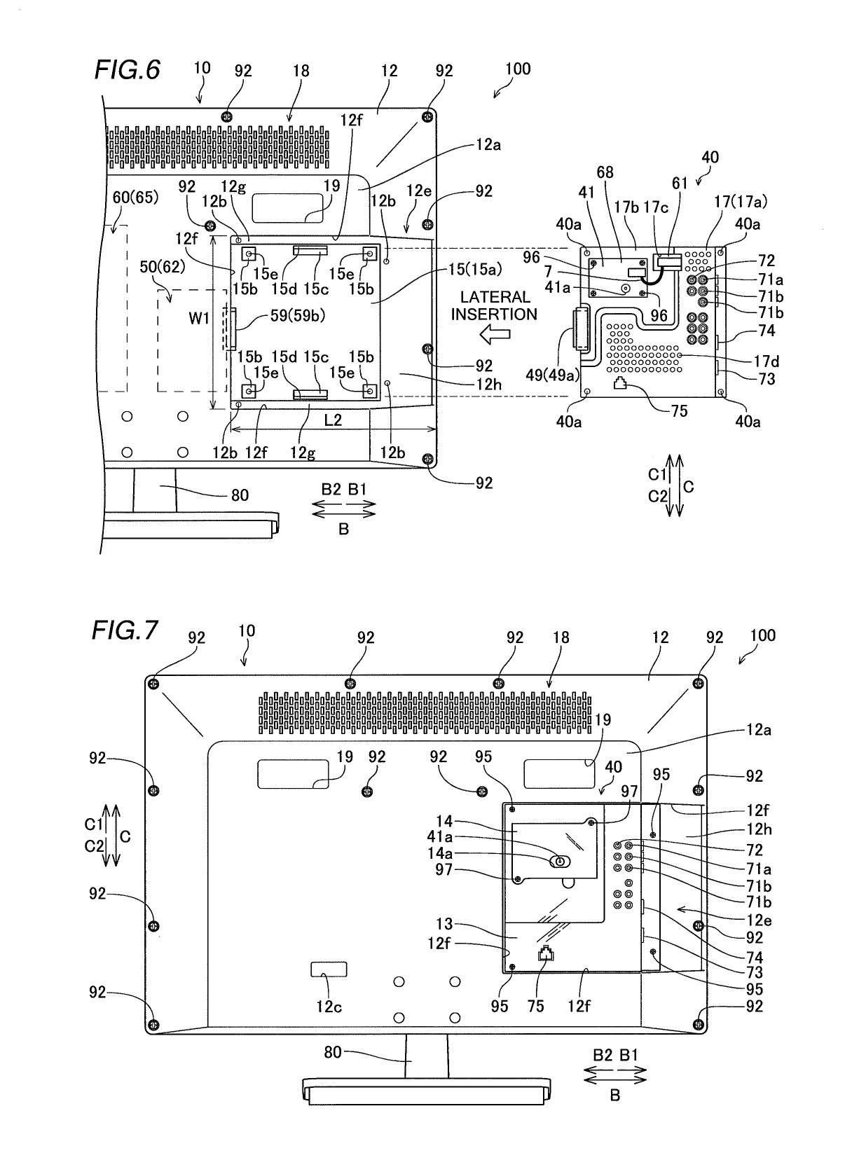

The front cabinet 11 is provided in the form of a frame having a substantially rectangular opening 11a. The back surface (rear surface) of an LCD (liquid crystal display) panel 21 of the display 20 is mounted on a chassis 15 (see FIG. 4) of metal (sheet metal). As shown in FIG. 4, the chassis 15 is mounted on the front cabinet 11 (see FIG. 1) from the rear side (this side of FIG. 4) toward the front side (the other side of FIG. 4) of the television set body 10 with a plurality of screw members 91. Thus, the LCD panel 21 is exposed from the opening 11a of the front cabinet 11 on the front side (A1 side) of the liquid crystal television set 100, as shown in FIG. 1. As shown in FIGS. 2 and 6, the rear cabinet 12 is mounted on the front cabinet 11 from the side of a back surface 12a toward the front side with a plurality of screw members 92. Thus, almost an entire region of the back surface of the chassis 15 is covered with the rear cabinet 12.

As shown in FIG. 1, the liquid crystal television set 100 includes a pair of sound speakers 22 provided inside the front cabinet 11 below the display 20, a clock display 23 displaying the current time provided on the front surface (A1 side) of the front cabinet 11 between the pair of sound speakers 22 (in a direction B), an IR sensor 24 detecting an infrared signal provided in the vicinity of the clock display 23 on the front surface of the front cabinet 11, and an ambient sensor 25 detecting the illuminance of a room (indoor environment) provided in the vicinity of the IR sensor 24. The display 20, the sound speakers 22, the clock display 23, the IR sensor 24, and the ambient sensor 25 are electrically connected with a control broad portion 30 described later. As shown in FIG. 2, the liquid crystal television set 100 includes a power cable 26 having a prescribed length. The power cable 26 is drawn into the television set body 10 through a hole 12c formed in the rear cabinet 12 to be connected to the control board portion 30 inside.

As shown in FIG. 1, the liquid crystal television set 100 includes the control board portion 30 in the television set body 10. As shown in FIG. 4, the control board portion 30 has a prescribed layout on the back surface 15a (this side of FIG. 4) of the chassis 15. The control board portion 30 has a function of outputting an image and sound included in a received television broadcast wave to the display 20 and the sound speakers 22 after selectively receiving the television broadcast wave having a specific frequency. The television broadcast wave that the liquid crystal television set 100 can receive includes a digital terrestrial broadcasting wave, a digital satellite broadcasting wave (BS satellite broadcasting, CS satellite broadcasting), a television broadcast wave employing a cable line (including an optical cable line (Internet connection)), etc. The structure of the control board portion 30 is now described in detail.

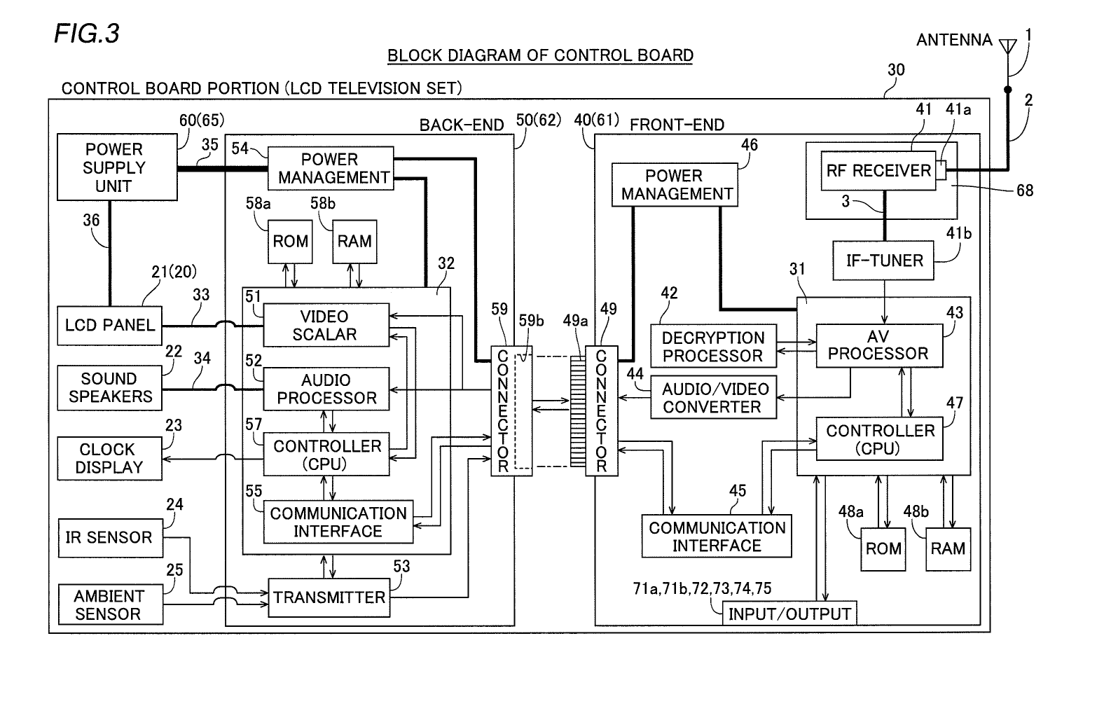

The control board portion 30 includes a front-end 40 having a function of receiving a television broadcast signal transmitted from a broadcast station, a back-end 50 having a function of outputting a video signal and an audio signal input through the front-end 40 to the display 20 and the sound speakers 22, respectively, and a power supply unit 60 having a function of supplying power to the front-end 40 and the back-end 50, as shown in FIG. 3.

According to this embodiment, the front-end 40 includes an RF receiver 41, an IF-tuner 41b, a decryption processor 42, an AV processor 43, an AV (audio/video) converter 44, a communication interface 45, a power management 46, a controller 47, a ROM (read only memory) 48a, and a RAM (random access memory) 48b. The front-end 40 further includes a PCB (printed circuit board) 61. The AV processor 43 and the controller 47 are formed in a single SOC (system-on-a-chip) 31. Further, components of the RF receiver 41 to the RAM 48b are formed to communicate a control signal to each other through a transmission line (bus) (not shown) provided on the PCB 61. The AV processor 43 is an example of the “decoder separating a broadcast signal (television broadcast signal) into a video signal and an audio signal” in the present invention. The PCB 61 is an example of the “first printed circuit board” in the present invention.

The RF receiver 41 is connected to an antenna cable (coaxial cable) 2 drawn into a room from an antenna 1 set outside a building or the like. Specifically, the RF receiver 41 has a terminal 41a (see FIG. 2) protruding to the back surface of the television set body 10, and the antenna cable 2 is connected to this terminal 41a. The IF-tuner 41b is connected through a cable 3 provided for transmitting a television broadcast signal on the downstream of the RF receiver 41. The IF-tuner 41b has a function of converting a television broadcast signal received by the RF receiver 41 into a digital TS (transport stream) signal. The decryption processor 42 is connected to the AV processor 43 arranged on the downstream of the IF-tuner 41b to be capable of communicating with the same and has a function of a cancelling a scramble signal (copy protection) included in the TS signal in an encoded state after demodulation by the IF-tuner 41b.

The AV processor 43 has a function of separating the TS signal into a video signal, an audio signal, other service information (PSI/SI: program specific information/service information), etc. and decoding the same by decrypting this TS signal in which a scramble function has been cancelled. The AV converter 44 has a function of converting the video signal and the audio signal from the AV processor 43 into a signal format based on the HDMI (high-definition multimedia interface) standard. The communication interface 45 is provided as an input/output interface on communication when the video signal, the audio signal, the service information, etc. transmitted from the AV converter 44 are transferred from the front-end 40 to the back-end 50.

The power management 46 is formed to be capable of communicating with a power management 54 of the back-end 50 described later. The power state of the front-end 40 is managed by the power management 46 on the basis of an instruction of the controller 47. The controller 47 includes a CPU (central processing unit) and has a function of controlling the aforementioned components in a processing circuit constituting the front-end 40. The ROM 48a stores a control program executed by the controller 47 and various data. The RAM 48b is employed as a working area temporarily storing control data generated when the controller 47 executes the control program.

According to this embodiment, the back-end 50 includes a video scalar 51, an audio processor 52, a transmitter 53, the power management 54, a communication interface 55, a controller 57, a ROM (read only memory) 58a, and a RAM (random access memory) 58b. The back-end 50 further includes a PCB (printed circuit board) 62. The video scalar 51, the audio processor 52, the communication interface 55, and the controller 57 are formed in a single SOC (system-on-a-chip) 32. Further, components of the video scalar 51 to the RAM 58b are formed to communicate a control signal to each other through a transmission line (bus) (not shown) provided on the PCB 62. The transmitter 53 is an example of the “transmitter receiving an operation signal” in the present invention. The PCB 62 is an example of the “second printed circuit board” in the present invention.

The video scalar 51 has a function of performing various processing on the video signal transferred from the front-end 40. Digital/analog conversion (D/A conversion) processing is performed on the video signal in the video scalar 51, and thereafter the video signal is output to the display 20 through a cable 33 connecting the PCB 62 and the LCD panel 21 to each other. The audio processor 52 has a function of performing various processing on the audio signal transferred from the front-end 40. D/A conversion processing is performed on the audio signal in the audio processor 52, and thereafter the audio signal is output from the sound speakers 22 through a pair of cables 34 (see FIG. 4) connecting the PCB 62 and the sound speakers 22 to each other.

The transmitter 53 has a function of receiving an operation signal detected by the IR sensor 24 and informing the controller 57 in the SOC 32 of capability of reception. This operation signal denotes an electrical signal into which an infrared signal is converted when the IR sensor 24 detects this infrared signal transmitted with a remote control transmitter (not shown) or the like by a user. The transmitter 53 has a function of receiving a signal representing the brightness of a room detected by the ambient sensor 25 and transmitting the same to the controller 57. The IR sensor 24 may be formed to have the function of the transmitter 53.

The power management 54 has a function of managing and controlling power supplied from the power supply unit 60 described later to the back-end 50. The power state of the back-end 50 is managed by the power management 54 on the basis of an instruction of the controller 57.

The communication interface 55 is provided as an input/output interface for receiving the video signal, the audio signal, etc. transferred from the front-end 40 on the side of the back-end 50. The controller 57 includes a CPU (central processing unit) and has a function of controlling not only the power supply unit 60 described later but also the aforementioned components in a processing circuit constituting the back-end 50. The ROM 58a stores a control program executed by the controller 57 and various data. The RAM 58b is employed as a working area temporarily storing control data generated when the controller 57 executes the control program.

Electronic components (not shown) constituting the power supply unit 60 are provided on the PCB (printed circuit board) 65. The power supply unit 60 is connected to the power cable 26 (see FIG. 2) extending outward from the television set body 10. The power supply unit 60 (PCB 65) and the power management 54 of the back-end 50 are electrically connected with each other through a dedicated cable 35. Thus, power is supplied from the power supply unit 60 to the back-end 50 (PCB 62). Further, the power supply unit 60 (PCB 65) and the display 20 are electrically connected with each other through a dedicated cable 36. Thus, power for a backlight (not shown) is supplied from the power supply unit 60 to the display 20.

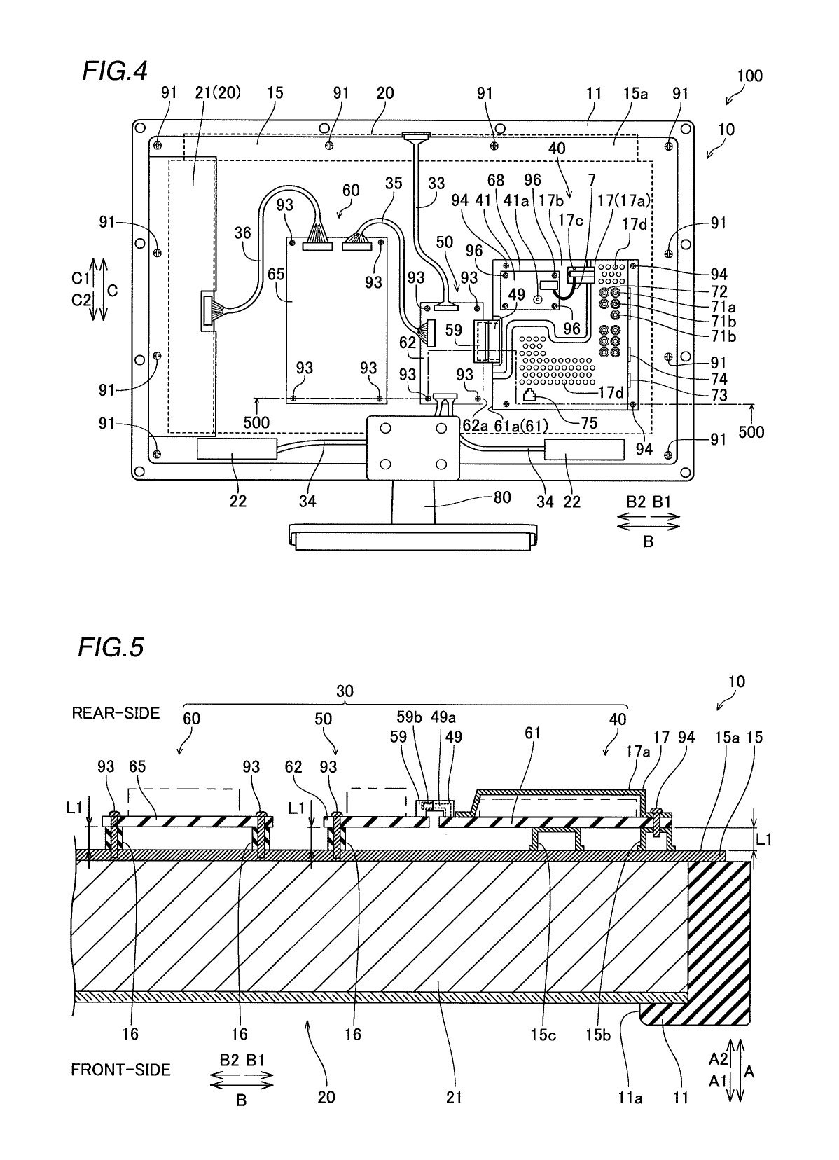

In the liquid crystal television set 100, the front-end 40 including the PCB 61 (see FIG. 5) is physically separated from the back-end 50 including the PCB 62, as shown in FIG. 4. In other words, the PCB 61 constituting the front-end 40 and the PCB 62 constituting the back-end 50 are mounted on the back surface 15a (this side of FIG. 4) of the chassis 15 independently of each other. At this time, the PCB 62 constituting the back-end 50 is fixed to the back surface 15a of the chassis 15 with screw members 93 (four screw members in this embodiment) without presupposing removal from the television set body 10. On the other hand, the PCB 61 constituting the front-end 40 is detachably mounted on a mounting portion 15b of the back surface 15a of the chassis 15 with screw members 94 (four screw members in this embodiment) in a position adjacent to the right side (B1 side) of the PCB 62 constituting the back-end 50. Therefore, the front-end 40 can be connected to and disconnected from the back-end 50.

As shown in FIGS. 4 and 5, a shield plate 17 is arranged to cover the PCB 61. The front-end 40 is detachably mounted on the mounting portion 15b of the chassis 15 with the screw members 94 in a state where the PCB 61 and the shield plate 17 are integrated.

According to this embodiment, a male header 49 is mounted on the PCB 61 constituting the front-end 40, and a female receptacle 59 is mounted on the PCB 62 constituting the back-end 50, as shown in FIGS. 4 and 5. The male header 49 is a connecting member having a socket 49a (see FIGS. 3 and 5) formed to convexly protrude outward beyond the PCB 61. The female receptacle 59 is a connecting member having a socket 59b (see FIGS. 3 and 5) formed to be concavely recessed toward the inside of the PCB 62. The male header 49 and the female receptacle 59 are examples of the “connecting member” in the present invention.

The male header 49 and the female receptacle 59 are provided on a side portion 61a of the PCB 61 and a side portion 62a of the PCB 62 opposed to each other, respectively, such that the sockets 49a and 59a are opposed to each other. In other words, the male header 49 is fixed to the vicinity of the side portion 61a of the PCB 61 such that the convex socket 49a is directed toward the PCB 62 (in a direction B2). The female receptacle 59 is fixed to the vicinity of the side portion 62a of the PCB 62 such that the concave socket 59b is directed toward the PCB 61 (in a direction B1).

As shown in FIG. 5, in a state where the PCB 61 and the PCB 62 are fixed onto the back surface 15a of the chassis 15, the convex male header 49 on the side of the PCB 61 is fitted into the concave female receptacle 59 on the side of the PCB 62, whereby the detachable PCB 61 constituting the front-end 40 is physically and electrically connected to the fixed PCB 62 constituting the back-end 50. Thus, the front-end 40 is detachably connected to the television set body 10 having the back-end 50 (the outer shape of the PCB 62 is indicated by a broken line) built-in, as shown in FIG. 6.

As shown in FIG. 5, the PCB 61 and the PCB 62 are arranged in positions separated upward (in a direction A2) from the back surface 15a of the chassis 15 with substantially the same distance L1. The mounting portion 15b (four mounting portions in total) on which the PCB 61 is placed may be a mounting portion 15b formed by pressing the tabular chassis 15 to provide a convex portion protruding upward (in the direction A2) from the back surface 15a by the distance L1. Alternatively, the mounting portion 15b may be a mounting portion 15b formed by mounting a separate member having leg portions and provided in the form of a table on the back surface 15a of the chassis 15 by spot welding or the like.

As shown in FIGS. 5 and 6, a mounting portion 15c (two mounting portions in total) having a guide portion 15d (see FIG. 6) formed by folding sheet metal or the like is provided between each pair of the mounting portions 15b arranged at a prescribed interval in a transverse direction (direction B) on the back surface 15a. The mounting portion 15c extends in the direction B by a prescribed distance. Thus, when the PCB 61 (see FIG. 4) is fixed with the screw members 94, the PCB 61 is first slid in the direction B2 while being guided by the guide portion 15d on the mounting portion 15c separated by the distance L1 from the back surface 15a. Then, in a state where holes 40a (see FIG. 6) formed in four corners of the front-end 40 overlap with corresponding holes 15e (see FIG. 6) formed in the mounting portion 15b in plan view, the screw members 94 (see FIG. 4) are attached. The convex male header 49 (see FIG. 4) of the PCB 61 is completely fitted into the concave female receptacle 59 (see FIG. 4) of the PCB 62 at a position where the holes 40a of the front-end 40 and the holes 15e of the mounting portion 15b overlap with each other.

As shown in FIG. 5, the PCB 62 is fixed to the back surface 15a of the chassis 15 through a spacer member 16 having insulating properties with the screw members 93. The height of the spacer member 16 is substantially equal to the distance L1. Therefore, the detachable front-end 40 (PCB 61) is slid from right (B1 side) to left (B2 side) on the mounting portion 15c in substantially the same plane as the fixed PCB 62 to be connected to the PCB 62. Thus, according to this embodiment, the front-end 40 is slid in substantially the same plane in which the back-end 50 is arranged to be attached to and detached from the back-end 50 of the television set body 10.

The PCB 65 constituting the power supply unit 60 is also fixed to the back surface 15a of the chassis 15 through spacer members 16 identical to the spacer member employed in the PCB 62 with screw members 93 (four screw members in this embodiment).

According to this embodiment, connecting members capable of performing communication based on the HDMI standard are applied as the male header 49 and the female receptacle 59, as shown in FIG. 3. Thus, the front-end 40 and the back-end 50 provided separately from each other can perform the communication based on the HDMI standard with each other in a state where the front-end 40 is connected to the back-end 50. In this case, the video signal and the audio signal decoded by the AV processor 43 of the front-end 40 are input from the front-end 40 to the back-end 50 in a signal format set on the basis of the HDMI standard by the AV converter 44. The video signal and the audio signal are communicated on the basis of the HDMI standard, and hence digital data (digital content) is transferred to the back-end 50 under conditions in which digital rights that the television broadcast signal has are properly managed (DRM (digital rights management) is secured) even if the front-end 40 includes the AV processor 43.

The front-end 40 and the back-end 50 communicate with each other on the basis of the HDMI standard, and hence in the control board portion 30, the front-end 40 can be controlled by a control signal based on the HDMI-CEC (consumer electronics control) specification, for example, transmitted through the communication interface 55 from the back-end 50.

The male header 49 and the female receptacle 59 are connected with each other, whereby not only the video signal and the audio signal can be transferred between the front-end 40 and the back-end 50 on the basis of the HDMI standard, but also a control signal (CEC signal) can be communicated between the front-end 40 and the back-end 50. RS-232 (Recommended Standard 232), for example, may be employed as a communication system related to an internal control operation between the front-end 40 and the back-end 50.

According to this embodiment, in a state where the front-end 40 is connected to the back-end 50, power for activating the front-end 40 is supplied from the power management 54 of the back-end 50 connected to the power supply unit 60 through the cable 35 to the front-end 40, as shown in FIG. 3. The male header 49 and the female receptacle 59 formed in accordance with the terminal specification based on the HDMI standard are provided with terminals for power supply. Thus, the power supplied from the power management 54 is supplied to not only other components of the back-end 50 but also the front-end 40 through the female receptacle 59 and the male header 49.

According to this embodiment, an operation signal from a remote control transmitter (not shown) received by the transmitter 53 connected to the IR sensor 24 is also transmitted to the front-end 40 by connection between the female receptacle 59 and the male header 49, as shown in FIG. 3. Thus, the front-end 40 operates on the basis of a user operation with the remote control transmitter (not shown). When the user selects a channel with the remote control transmitter, for example, the RF receiver 41 of the front-end 40 performs an operation of selecting the channel.

According to this embodiment, the AV processor 43 separating and decoding the TS signal is provided in the front-end 40, as shown in FIG. 3. Therefore, the decryption processor 42 for cancelling a scramble signal (copy protection) connected to the AV processor 43 is also provided in the front-end 40. The control board portion 30 is formed in the aforementioned manner.

As shown in FIGS. 6 and 7, in a state where the PCB 62 constituting the back-end 50 is previously mounted on the back surface 15a of the chassis 15, the back surface of the back-end 50 (PCB 62) is almost covered with the rear cabinet 12 of resin.

According to this embodiment, the rear cabinet 12 includes an opening 12e formed by partially notching the back surface 12a (A2 side), as shown in FIG. 1. As shown in FIG. 6, the opening 12e is formed with an opening width W1 (see FIG. 6) in the middle of the right (B1 side) side portion of the rear cabinet 12 in a direction C. The opening 12e has a depth L2 from the side portion toward the inside (B2 side) of the rear cabinet 12. The opening 12e has inner surfaces 12f extending substantially perpendicularly from the back surface 12a of the rear cabinet 12 toward the chassis 15, a pair of flange portions 12g extending substantially parallel to the back surface 15a of the chassis 15 on ends of the inner surfaces 12f on the side of the chassis 15 (opposite to the back surface 12a), and a connection portion 12h connecting this pair of flange portions 12g with each other in the direction c in a right (B1-side) region of the opening 12e. The inner surfaces 12f are formed on upper and lower portions (C1 and C2 sides) of the opening 12e. The inner surfaces 12f are connected with each other vertically (in the direction c) on the left end (B2 side) of the opening 12e excluding the vicinity of a region where the female receptacle 59 of the PCB 62 is exposed from the opening 12e. Holes 12b (four holes in total) are formed in prescribed positions of the flange portions 12b and the connection portion 12h. The opening 12e has the inner surfaces 12f, the flange portions 12g, and the connection portion 12h, whereby the strength of the rear cabinet 12 around the opening 12e is secured. The opening 12e is an example of the “first opening” in the present invention.

As shown in FIG. 6, in a state where the front-end 40 has not been mounted yet, the back surface 15a of the chassis 15 and the mounting portions 15b and 15c are exposed from a portion of the opening 12e excluding the flange portions 12g and the connection portion 12h in plan view. Thus, the front-end 40 can be attached to the television set body 10 (back-end 50) through the opening 12e of the rear cabinet 12. In this case, the front-end 40 is slid in the direction B2 (transverse direction) from the right relative to the opening 12e along the inner surfaces 12f of the opening 12e in a vertical direction (direction C). The inner surfaces 12f opposed to each other in the vertically direction (direction C) in the opening 12e are formed substantially parallel to each other, and hence the inner surfaces 12f also serve a guiding function when the front-end 40 is slid in the direction B2. The front-end 40 is slid in the direction B2 by a length L2 in the opening 12e, and thereafter the male header 49 is connected to the female receptacle 59 of the back-end 50.

According to this embodiment, the liquid crystal television set 100 further includes a cover member 13 of resin, as shown in FIGS. 2 and 7. The cover member 13 blocks up the opening 12e of the rear cabinet 12 and has a function of covering the front-end 40 (PCB 61). In a state where the front-end 40 (PCB 61) is connected to the back-end 50 (PCB 62), the cover member 13 covers the front-end 40 from the side of a back surface (this side of FIG. 7) and is mounted on the rear cabinet 12 with screw members 95 (four screw members in this embodiment). In this case, as shown in FIG. 7, in a state where holes (four holes) provided in the cover member 13 into which the screw members 95 are inserted and the holes 12b (see FIG. 6) provided in the pair of flange portions 12g and the connection portion 12h of the rear cabinet 12 overlap with each other in plan view, the screw members 95 are attached. The cover member 13 covers the front-end 40, whereby the screw members 94 for mounting the front-end 40 on the chassis 15 are also hidden by the cover member 13. The cover member 13 is an example of the “first cover member” in the present invention.

Therefore, only the relatively small-sized cover member 13 can be detached from the opening 12e of the rear cabinet 12 without detaching the relatively large-sized rear cabinet 12 from the television set body 10, when the front-end 40 is detached from the television set body 10. Thus, the front-end 40 can be slid to the right (B1 side) to be detached from the television set body 10 (back-end 50) through the opening 12e from which the cover member 13 is detached.

According to this embodiment, the RF receiver 41 serving as a receiving portion included in the front-end 40 is detachably mounted on a body of the front-end 40. Specifically, the RF receiver 41 is mounted on a PCB 68 while constituting a single electronic component (tuner device), as shown in FIG. 4. Therefore, the PCB 68 mounted with the RF receiver 41 is physically separated from the PCB 61 mounted with the IF-tuner 41b to the RAM 48b. In this state, the PCB 68 is detachably connected to the PCB 61. In other words, according to this embodiment, the PCB 61 and the PCB 68 constitute the front-end 40. The PCB 68 is an example of the “third printed circuit board” in the present invention.

In this case, the shield plate 17 of metal (sheet metal) covering most of the PCB 61 from above is mounted on the PCB 61 in a state insulated from the PCB 61, as shown in FIG. 4. The upper surface 17a of the shield plate 17 has a concave portion 17b formed by press working of sheet metal. The shield plate 17 is arranged on the PCB 61 such that the bottom surface of the concave portion 17b is closer to the PCB 61 than the upper surface 17a other than the concave portion 17b. The PCB 68 is detachably mounted on the bottom surface of the concave portion 17b with screw members 96 (four screw members in this embodiment) in a state insulated from the shield plate 17.

As shown in FIG. 4, the shield plate 17 is formed with an opening 17c in a region from the concave portion 17b to the upper surface 17a on the right side (B1 side) of the PCB 68. Thus, the cable 3 provided for transmitting a broadcast signal connects the RF receiver 41 (see FIG. 3) of the PCB 68 and the IF-tuner 41b (see FIG. 3) of the PCB 61 with each other through this opening 17c. A plurality of holes 17d (see FIG. 4) for facilitating radiation of heat from the front-end 40 are provided in a portion of the upper surface 17a of the shield plate 17 on which the PCB 68 is not mounted.

According to this embodiment, the PCB 68 is arranged to be superimposed on the shield plate 17 in plan view, as shown in FIG. 4. In other words, the PCB 68 is superimposed on the PCB 61. Thus, the PCB 68 having a relatively small plane area is arranged in a region of the PCB 61 having a relatively large plane area.

According to this embodiment, the RF receiver 41 can receive a control signal transmitted from an external system in addition to a broadcast signal. In other words, when a plurality of the liquid crystal television sets 100 are set in a hotel, a leisure facility, a school, a hospital, or the like, each of the liquid crystal television sets 100 can be controlled by a management system (external system) provided in the facility. In the aforementioned facility, users of the facility may operate the liquid crystal television sets 100 with the remote control transmitters, or the facility (management system) may control each of the liquid crystal television sets 100 to receive a broadcast signal. In this case, the front-end 40 of each of the liquid crystal television sets 100 is controlled by the control signal transmitted from the management system that the RF receiver 41 can receive. Therefore, the liquid crystal television set 100 according to this embodiment can be set in the facility that many and unspecified users use and used under the management system provided in the facility.

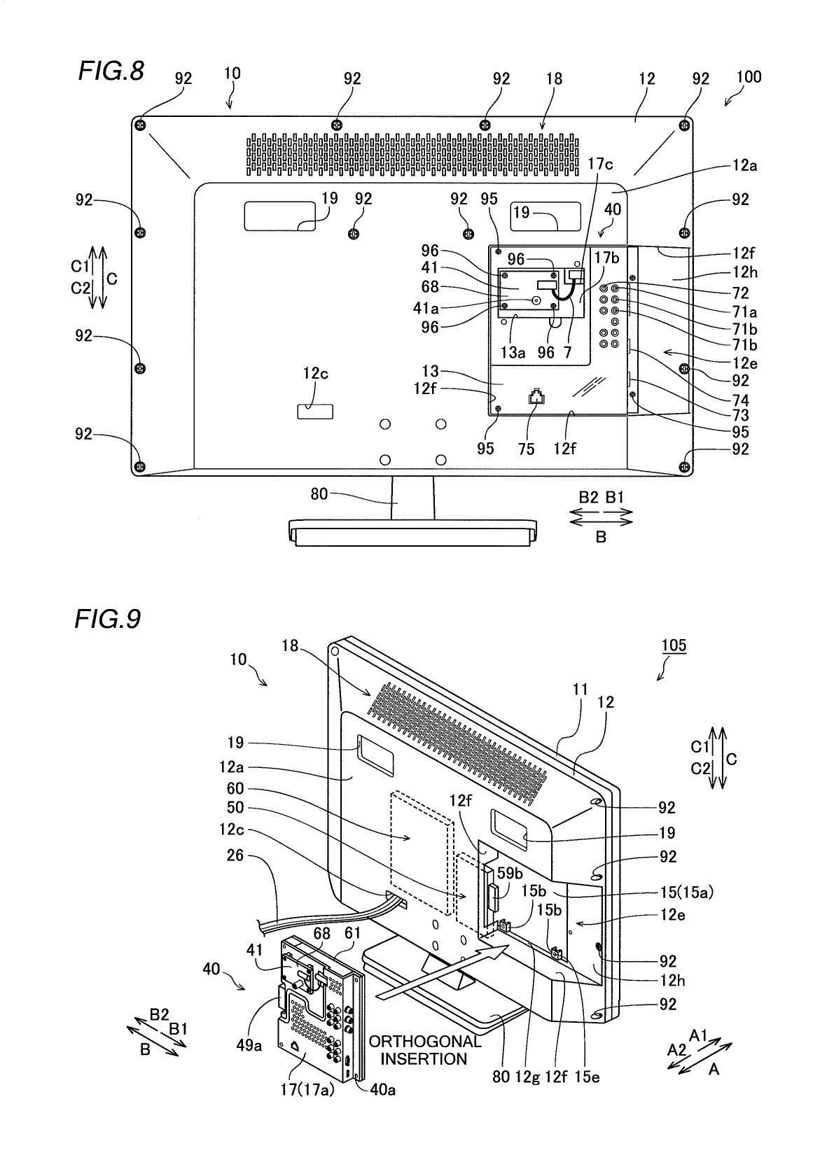

According to this embodiment, the front-end 40 has the following features. In other words, the cover member 13 covering the front-end 40 includes an opening 13a provided to correspond to a position where the RF receiver 41 is mounted, as shown in FIG. 8. The liquid crystal television set 100 includes a cover member 14 of resin covering the opening 13a of the cover member 13, as shown in FIG. 7. The cover member 14 is mounted on the cover member 13 with screw members 97. Therefore, the cover member 14 is detached from the cover member 13 in a state where the cover member 13 covers the front-end 40, whereby the RF receiver 41 can be detached through the opening 13a. The opening 13a is an example of the “second opening” in the present invention, and the cover member 14 is an example of the “second cover member” in the present invention.

As shown in FIG. 7, the cover member 14 is provided with a hole 14a in a position corresponding to the terminal 41a of the RF receiver 41. Thus, the terminal 41a is exposed from the hole 14a to the rear side (this side of FIG. 7) even if the cover member 14 is mounted on the cover member 13 while the RF receiver 41 is mounted on the shield plate 17.

In the liquid crystal television set 100, a plurality of terminal portions for a plurality of external connections are provided on the back surface (A2 side) and side surface (B1 side) of the front-end 40, as shown in FIG. 2. Specifically, a video input terminal 71a, an audio input terminal 71b, an audio output terminal 72, an HDMI connection terminal 73, a USB connection terminal 74, and a LAN connection terminal 75 are provided. Thus, video and audio signals of an externally-connected device can be input from the video input terminal 71a and the audio input terminal 71b of the front-end 40 and output from the liquid crystal television set 100 through the back-end 50. Further, software driving the existing front-end 40 (AV processor 43) can be upgraded by connecting the front-end 40 to a PC (personal computer) or the like through the USB connection terminal 74 or the LAN connection terminal 75. As shown in FIG. 3, each of the aforementioned terminal portions (71a to 75) for external connection is connected to the communication interface 45. Thus, digital rights are properly protected also when a video signal and an audio signal are externally output through the audio output terminal 72 and the HDMI connection terminal 73.

As shown in FIG. 2, the rear cabinet 12 is formed with a plurality of holes 18 opening obliquely upward with respect to the back surface 12a of the television set body 10 and a pair of concave portions 19 each recessed inward from the back surface 12 to have a bottom portion. The holes 18 are provided to externally radiate heat generated from the inside of the television set body 10. The pair of concave portions 19 are formed such that the user can lift the television set body 10 by inserting his/her hands into the pair of concave portions when moving the liquid crystal television set 100. Thus, the liquid crystal television set 100 according to this embodiment is formed.

According to this embodiment, as hereinabove described, the liquid crystal television set 100 includes the front-end 40 having the AV processor 43 separating the television broadcast signal into the video signal and the audio signal and the back-end 50 provided separately from the front-end 40 and is formed such that the front-end 40 can be connected to and disconnected from the back-end 50. Thus, only the existing front-end 40 can be easily replaced with a new front-end 40 mounted with another AV processor without replacing the back-end 50, and the existing front-end 40 (AV processor 43) can be easily amended by easily upgrading the software driving the AV processor 43 serving as hardware. Therefore, at least the AV processor 43 can be easily replaced, and upgrade of at least the AV processor 43 can be easily performed.

According to this embodiment, when the front-end 40 and the back-end 50 are formed separately from each other, the front-end 40 includes the AV processor 43, and hence the video signal and the audio signal after decode by the AV processor 43 can be transferred from the front-end 40 to the back-end 50. In other words, the video signal and the audio signal after decode by the AV processor 43 are transferred from the front-end 40 to the separate back-end 50 on the basis of the HDMI standard communication specification in which copyright is protected (digital rights management is secured), and hence no arithmetic processing portion or the like for temporal encryption and decryption of the transferred video signal and audio signal may be additionally provided in the front-end 40 and the back-end 50. Thus, the structure of the front-end 40 and the back-end 50 can be inhibited from complication even when the front-end 40 and the back-end 50 capable of being physically separated from each other are employed. Further, no interface having a special processing function for the aforementioned encryption and decryption may be provided in the control board portion 30, and hence the degree of freedom in design of the front-end 40 and the back-end 50 can be inhibited from decrease.

According to this embodiment, the front-end 40 is formed detachably from the television set body 10, whereby the front-end 40 can be easily detached from the television set body 10 to be replaced in response to a delivery format, for example. Thus, broadcast signals delivered in various delivery formats can be received by the same liquid crystal television set 100. Further, the front-end 40 includes the AV processor 43, and hence the front-end 40 mounted with a new version of the AV processor 43 corresponding to a delivery format can be easily connected to the existing television set body 10 including the back-end 50. Thus, the liquid crystal television set 100 can be redesigned as a liquid crystal television set 100 capable of receiving a desired broadcast signal by replacing only the front-end 40 in the existing television set body 10 without renewal (replacement) of the whole liquid crystal television set 100 by the user.

Further, a developer/manufacturer can put all resources (development personnel, time, development facilities, etc.) into development of only the front-end 40 separated from the television set body 10 without newly developing the television set body 10 including the back-end 50 simply outputting a video signal and an audio signal and the power supply unit 60 each time a new delivery system comes to market. Consequently, the time required for development of the front-end 40 is reduced, and hence the load on development of the front-end 40 can be reduced. Further, a product corresponding to a trend among users can be quickly placed on the market.

According to this embodiment, the front-end 40 and the back-end 50 provided separately from each other are connected with each other to be capable of performing communication based on the HDMI standard, and the video signal and the audio signal decoded by the AV processor 43 of the front-end 40 are input from the front-end 40 to the back-end 50 in the signal format based on the HDMI standard transmitted from the AV converter 44. Thus, the communication based on the HDMI standard does not generate deterioration of data associated with compression and decompression, and the video signal and the audio signal can be transferred from the front-end 40 to the back-end 50.

According to this embodiment, the front-end 40 can be controlled by the control signal transmitted from the back-end 50 on the basis of the HDMI standard. Thus, the front-end 40 including the RF receiver 41 can be easily controlled from the television set body 10 including the back-end 50 by effectively employing a communications protocol defined in the HDMI standard.

According to this embodiment, the front-end 40 includes the decryption processor 42 cancelling a scramble signal (copy protection) included in the broadcast signal. Thus, the front-end 40 including the AV processor 43 is provided with the decryption processor 42, and hence in the front-end 40, the AV processor 43 can reliably separate the broadcast signal in which the scramble signal (copy protection) has been cancelled by the decryption processor 42 into the video signal and the audio signal and decode the same.

According to this embodiment, in a state where the front-end 40 and the back-end 50 provided separately from each other are connected with each other, power for activating the front-end 40 is supplied from the power supply unit 60 to the front-end 40 through the power management 54 of the back-end 50. Thus, no power supply portion (power circuit portion) or the like provided for driving the front-end 40 may be provided in the front-end 40, and hence the structure of the front-end 40 can be further inhibited from complication. Further, the television set body 10 can be formed such that the power supply unit 60 of the back-end 50 is also employed as a power source for the front-end 40, and hence the structure of the liquid crystal television set 100 can be simplified due to the shared power source.

According to this embodiment, the PCB 62 provided as the back-end 50 is mounted with the transmitter 53 receiving an operation signal for operating the television set body 10. The operation signal received by the transmitter 53 is transmitted to the front-end 40 through the communication interface 55, and the front-end 40 operates on the basis of the operation signal. Thus, the front-end 40 (RF receiver 41) can easily operate on the basis of the operation signal representing channel selection that the transmitter 53 of the back-end 50 receives even when the front-end 40 and the back-end 50 are formed separately from each other.

According to this embodiment, the front-end 40 includes the PCB 61 mounted with the AV processor 43, and the back-end 50 includes the PCB 62. The PCB 61 of the front-end 40 is detachably connected to the PCB 62 of the back-end 50. Thus, the PCB 61 and the PCB 62 different from each other can constitute the front-end 40 and the back-end 50, respectively, and hence the front-end 40 and the back-end 50 can be easily formed separately from each other. Further, the PCB 61 and the PCB 62 are physically connected with each other, whereby the front-end 40 and the back-end 50 provided separately from each other can be easily connected with each other.

According to this embodiment, the PCB 61 and the PCB 62 can be connected with each other through the connecting members (the male header 49 and the female receptacle 59) capable of performing communication based on the HDMI standard. Thus, the PCB 61 and the PCB 62 can be reliably connected with each other through the male header 49 and the female receptacle 59. Further, the connecting members capable of performing the communication based on the HDMI standard are employed to connect the front-end 40 and the back-end 50 with each other, whereby communication between the front-end 40 and the back-end 50 having been connected with each other can be easily performed on the basis of the HDMI standard.

According to this embodiment, the male header 49 of the PCB 61 is inserted into the female receptacle 59 of the PCB 62, whereby the PCB 61 can be connected to the PCB 62. Thus, the male header 49 is arranged on the PCB 61 attached to the PCB 62 while the female receptacle 59 is arranged on the PCB 62 attached with the PCB 61, and hence the front-end 40 including the PCB 61 can be easily connected to the back-end 50 including the PCB 62 by simply inserting the male header 49 (convex socket 49a) into the female receptacle 59 (concave socket 59b).

According to this embodiment, the front-end 40 (PCB 61) can be slid in the transverse direction (direction B) in substantially the same plane in which the back-end 50 (PCB 62) is arranged to be attached to and detached from the back-end 50 of the television set body 10. Thus, the front-end 40 can be easily attached to and detached from the back-end 50 of the television set body 10.

According to this embodiment, the RF receiver 41 is detachably mounted on the front-end 40. Thus, only the RF receiver 41 serving a receiving function can be replaced while the body of the front-end 40 remains in the liquid crystal television set 100, and hence the RF receiver 41 can be easily replaced in response to a delivery format when broadcast signals are delivered in various delivery formats.

According to this embodiment, the front-end 40 includes the PCB 68 mounted with the RF receiver 41 in addition to the PCB 61 mounted with the AV processor 43. The PCB 68 is detachably connected to the PCB 61. Thus, the PCB 68 can constitute the RF receiver 41 while the PCB 61 different from the PCB 68 can constitute the front-end 40 including components other than the RF receiver 41, and hence in the front-end 40, the RF receiver 41 and a portion other than the RF receiver 41 can be easily formed separately from each other. Further, the PCB 61 and the PCB 68 are physically connected with each other, whereby the RF receiver 41 can be easily connected to the front-end 40.

According to this embodiment, the PCB 68 is arranged to be superimposed on the PCB 61. Thus, the PCB 68 is superimposed on the PCB 61, and hence the installation area of the PCB 68 can be included in the installation area of the PCB 61. Therefore, the installation area of the front-end 40 can be inhibited from increase, dissimilarly to a case where the PCB 61 and the PCB 68 are arranged adjacent to each other in the same plane, for example.

According to this embodiment, the RF receiver 41 can receive a control signal transmitted from an external system (management system) provided in a facility such as a hotel, a leisure facility, a school, or a hospital in addition to a broadcast signal, and the front-end 40 can be controlled by the control signal transmitted from the external system that the RF receiver 41 can receive. Thus, the management system provided in the facility and managing a plurality of the liquid crystal television sets 100 together can be employed to control each of the liquid crystal television sets 100 properly.

According to this embodiment, the liquid crystal television set 100 includes the rear cabinet 12 covering the back-end 50 and having the opening 12e. The front-end 40 is formed detachably from the television set body 10 through the opening 12e of the rear cabinet 12. Thus, the front-end 40 may not be detached in a state where the whole rear cabinet 12 covering the back-end 50 is detached from the television set body 10 when the front-end 40 is detached from the television set body 10. In other words, the front-end 40 can be detached through the opening 12e without detaching the rear cabinet 12, and hence the front-end 40 can be easily detached.

According to this embodiment, the liquid crystal television set 100 includes the cover member 13 covering the opening 12e of the rear cabinet 12 and the front-end 40. The cover member 13 is detached from the opening 12e, whereby the front-end 40 can be detached from the television set body 10 through the opening 12e. Thus, the front-end 40 can be easily detached by simply detaching the cover member 13 from the opening 12e of the rear cabinet 12 and exposing the front-end 40 from the opening 12e when the front-end 40 is detached from the television set body 10.

According to this embodiment, the cover member 13 includes the opening 13a provided to correspond to the position where the RF receiver 41 of the front-end 40 is mounted, and the liquid crystal television set 100 includes the cover member 14 mounted on the cover member 13 to cover the opening 13a of the cover member 13. The cover member 14 is detached from the cover member 13 in a state where the cover member 13 covers the front-end 40, whereby the RF receiver 41 can be detached through the opening 13a. Thus, the RF receiver 41 may not be detached in a state where the whole cover member 13 covering the front-end 40 is detached from the rear cabinet 12 so that the front-end 40 is exposed from the opening 12e when the RF receiver 41 in the front-end 40 is detached. In other words, the RF receiver 41 can be detached through the opening 13a by detaching only the cover member 14 without detaching the cover member 13, and hence the RF receiver 41 can be easily detached.

Although the present invention has been described and illustrated in detail, it is clearly understood that the same is by way of illustration and example only and is not to be taken by way of limitation, the spirit and scope of the present invention being limited only by the terms of the appended claims.

For example, while the present invention is applied to the liquid crystal television set 100 as an example of a broadcasting receiver in the aforementioned embodiment, the present invention is not restricted to this. The present invention can be applied to a broadcasting receiver other than a liquid crystal television set, such as a plasma television set or a projection television set, for example. Alternatively, the present invention may be applied to not only a television set but also a broadcasting receiver such as a set-top box (signal conversion device) including a receiving portion receiving a broadcast signal or may be applied to a recorder such as a DVD recorder, a BD recorder, or an HDD recorder including a receiving portion receiving a broadcast signal. Alternatively, the present invention may be applied to a broadcasting receiver such as a portable information terminal or a portable telephone including a receiving portion receiving a broadcast signal. In a case where the present invention is applied to any of the broadcasting receivers, the existing television set body (back-end) can be reconfigured as a broadcasting receiver capable of receiving a desired broadcast signal by replacing only the front-end.

While the front-end 40 is attached to and detached from the television set body 10 along a direction (transverse direction (direction B)) substantially parallel to the chassis 15 in the aforementioned embodiment, the present invention is not restricted to this. For example, the front-end 40 may be formed as in a modification shown in FIG. 9. In other words, in a liquid crystal television set 105, a front-end 40 not covered with a cover member 13 may be attached and detached in a direction substantially perpendicular to a chassis 15 from the rear side (A2 side) of a television set body 10 toward the front side (A1 side). In this case, a direction (direction A) in which the front-end 40 is attached and detached is substantially orthogonal to the direction (direction B) in the aforementioned embodiment, and hence the shapes and the mounting positions of connecting members must differ from those of the liquid crystal television set 100.

For example, a male header on the side of the front-end 40 is preferably mounted on the lower surface (the lower surface of the PCB 61 shown in FIG. 5) of a PCB 61, and a socket must be directed downward (frontward (in a direction A1)). On the other hand, a female receptacle on the side of a back-end 50 is preferably mounted on the upper surface (the upper surface of the PCB 62 shown in FIG. 5) of a PCB 62, and a socket must be directed upward (backward (in a direction A2)). Thus, even if the front-end 40 approaches the chassis 15 along the direction substantially perpendicular to the chassis 15, connection terminals of the connecting members are opposed to each other along the direction A, and hence the PCB 61 and the PCB 62 can be easily connected with each other. The liquid crystal television set 105 is an example of the “broadcasting receiver” and the “television set” in the present invention.

While an opening 12e of a rear cabinet 12 has a notched shape in the modification shown in FIG. 9, the present invention is not restricted to this. If the front-end 40 is attached and detached along the direction substantially perpendicular to the chassis 15 from the rear side of the television set body 10 toward the front side, the opening for attaching and detaching the front-end 40 may be provided in the form of a hole completely surrounded by the back surface 12a of the rear cabinet 12.

While the male header 49 is mounted on the PCB 61 constituting the front-end 40 while the female receptacle 59 is mounted on the PCB 62 constituting the back-end 50 in the aforementioned embodiment, the present invention is not restricted to this. The female receptacle may be mounted on the PCB 61, and the male header may be mounted on the PCB 62.

While the front-end 40 and the back-end 50 are connected with each other by directly connecting the male header 49 mounted on the PCB 61 and the female receptacle 59 mounted on the PCB 62 with each other in the aforementioned embodiment, the present invention is not restricted to this. The PCB 61 and the PCB 62 may be connected with each other through a cable formed on the basis of the HDMI specification.

While the front-end 40 not covered with the cover member 13 is first mounted on the chassis 15 (mounting portion 15b) with the screw members 94, and thereafter the front-end 40 (shield plate 17) is covered with the cover member 13, and the cover member 13 is mounted on the rear cabinet 12 with the screw members 95, when the front-end 40 is mounted in the aforementioned embodiment, the present invention is not restricted to this. For example, the front-end 40 and the cover member 13 may be mounted on the chassis 15 with common screw members after the front-end 40 is connected to the back-end 50 and further covered with the cover member 13. Further, the front-end 40 may be fixed to the chassis 15 with fixing members other than the screw members, and the cover member 13 may be fixed to the rear cabinet 12 with fixing members other than the screw members. For example, one component may engage with the other component by providing elastically deformable engaging portions (engaging pawls) and portions to be detachably engaged with the engaging portions on the components.

While the liquid crystal television set 100 includes the stand portion 80 capable of being set on a table in the aforementioned embodiment, the present invention is not restricted to this. In the present invention, the television set body 10 may be formed to be mounted on a wall surface without having the stand portion 80 or the like. For example, a support portion (arm member) for mounting the television set body 10 on the wall surface may be provided on a portion of the back surface 12a of the rear cabinet 12 excluding the opening 12e. Even if the television set body 10 is mounted on the wall surface, the front-end 40 can be attached to and detached from the television set body 10 along the direction (transverse direction (direction B)) substantially parallel to the chassis 15. Therefore, the front-end 40 can be easily attached and detached by inserting and extracting the front-end 40 in the transverse direction even if sufficient space is not secured between the rear cabinet 12 and the wall surface.

What is claimed is:

1. A broadcasting receiver comprising:
a front-end including an RF receiver receiving a broadcast signal and a decoder separating said broadcast signal received by said RF receiver into a video signal and an audio signal; and
a back-end provided separately from said front-end, outputting said video signal and said audio signal input from said front-end through said decoder, wherein
said front-end can be connected to and disconnected from said back-end.

2. The broadcasting receiver according to claim 1, wherein
said front-end is formed detachably from a receiver body.

3. The broadcasting receiver according to claim 1, wherein
said front-end and said back-end provided separately from each other are connected with each other to be capable of performing communication based on an HDMI standard, and
said video signal and said audio signal obtained by separation of said broadcast signal by said decoder of said front-end are input from said front-end to said back-end in a signal format based on the HDMI standard.

4. The broadcasting receiver according to claim 3, wherein
said front-end can be controlled by a control signal transmitted from said back-end on the basis of the HDMI standard.

5. The broadcasting receiver according to claim 1, wherein
said front-end further includes a decryption processor cancelling copy protection included in said broadcast signal.

6. The broadcasting receiver according to claim 1, wherein
power for activating said front-end is supplied from said back-end to said front-end in a state where said front-end and said back-end provided separately from each other are connected with each other.

7. The broadcasting receiver according to claim 1, wherein
said back-end is provided with a transmitter receiving an operation signal for operating a receiver body, and
said operation signal received by said transmitter of said back-end is transmitted to said front-end so that said front-end operates on the basis of said operation signal.

8. The broadcasting receiver according to claim 1, wherein
said front-end includes a first printed circuit board mounted with said decoder while said back-end includes a second printed circuit board, and
said first printed circuit board of said front-end is detachably connected to said second printed circuit board of said back-end.

9. The broadcasting receiver according to claim 8, wherein
said first printed circuit board and said second printed circuit board can be connected with each other through connecting members capable of performing communication based on an HDMI standard.

10. The broadcasting receiver according to claim 9, wherein
said connecting members include a male header provided on said first printed circuit board and a female receptacle provided on said second printed circuit board, and
said first printed circuit board can be connected to said second printed circuit board by inserting said male header of said first printed circuit board into said female receptacle of said second printed circuit board.

11. The broadcasting receiver according to claim 1, wherein
said RF receiver is detachably mounted on said front-end.

12. The broadcasting receiver according to claim 11, wherein
said front-end further includes a third printed circuit board mounted with said RF receiver in addition to a first printed circuit board mounted with said decoder, and
said third printed circuit board is detachably connected to said first printed circuit board.

13. The broadcasting receiver according to claim 12, wherein
said third printed circuit board is arranged to be superimposed on said first printed circuit board.

14. The broadcasting receiver according to claim 11, wherein
said RF receiver can receive a control signal transmitted from an external system in addition to said broadcast signal, and
said front-end can be controlled by said control signal transmitted from said external system that said RF receiver can receive.

15. The broadcasting receiver according to claim 1, further comprising a rear cabinet covering said back-end and including a first opening, wherein
said front-end is formed detachably from a receiver body through said first opening of said rear cabinet.

16. The broadcasting receiver according to claim 15, further comprising a first cover member covering said first opening of said rear cabinet and said front-end, wherein
said front-end can be detached from said receiver body through said first opening by detaching said first cover member from said first opening.

17. The broadcasting receiver according to claim 16, wherein
said RF receiver can receive a control signal transmitted from an external system in addition to said broadcast signal and is detachably mounted on said front-end,
said RF receiver corresponding to receivable said broadcast signal and said control signal transmitted from said external system is mounted on said front-end, and
said first cover member includes a second opening provided to correspond to a position where said RF receiver of said front-end is mounted,
the broadcasting receiver further comprising a second cover member mounted on said first cover member to cover said second opening of said first cover member, wherein
said RF receiver can be detached through said second opening by detaching said second cover member from said first cover member in a state where said first cover member covers said front-end.

18. The broadcasting receiver according to claim 1, wherein
said front-end can be slid in substantially the same plane in which said back-end is arranged to be detached from said back-end of a receiver body.

19. A television set comprising:
a front-end including an RF receiver receiving a television broadcast signal and a decoder separating said television broadcast signal received by said RF receiver into a video signal and an audio signal;
a back-end provided separately from said front-end, outputting said video signal and said audio signal input from said front-end through said decoder;
a display displaying said video signal output from said back-end; and
sound speakers outputting said audio signal output from said back-end, wherein
said front-end can be connected to and disconnected from said back-end.

20. The television set according to claim 19, wherein
said front-end is formed detachably from a television set body.
